(19) United States
(12) Patent Application Publication
(10) Pub. No.: US 2026/0147618 A1
(43) Pub. Date: May 28, 2026

(54) NON-DISRUPTIVE RESIZING OF RESOURCE ARRAYS

(71) Applicant: Oracle International Corporation, Redwood Shores, CA (US)

(72) Inventors: Marco Uriel Gomez, Jalisco (MX); Bill Ingham, Romsey (GB); Francisco Rafael Flores Michel, Belmont, CA (US); Wilson Wai Shun Chan, San Francisco, CA (US)

(73) Assignee: Oracle International Corporation, Redwood Shores, CA (US)

(21) Appl. No.: 18/959,247

(22) Filed: Nov. 25, 2024

(51) Int. Cl. G06F 9/50

(52) U.S. Cl. CPC G06F 9/5016; G06F 9/5033

(57) ABSTRACT

Systems, methods, and computer readable media are presented to determine that a condition has been satisfied for resizing an array. A new storage unit is created, and a first storage unit is referenced from the new storage unit. A hash table header is updated to enable the first storage unit and the new storage unit for routing new hash table requests. When a request for a resource is received, a determination is made that the resource maps to the new storage unit and previously mapped to the first storage unit. The first storage unit is identified based on at least a reference of the new storage unit, and a latch is acquired on the first storage unit. The latch is used to remove a first resource mapping for the resource from the first storage unit and add a second resource mapping for the resource to the new storage unit before releasing the latch on the first storage unit.

### BACKGROUND

Database systems manage lookup data structures, such as hash tables, to provide an efficient lookup mechanism for database records. Database systems may rearrange or otherwise manage the elements of the lookup data structures as the data changes. Changes to organization of the lookup data structures may not be made on the fly due to the active use of the lookup data structures to support record lookup operations. For significant changes to the data structures, the database system may be inaccessible to continue to process record requests. Freezing record requests allows the lookup data structures to be reconfigured without ongoing changes being made to the records referenced by the lookup data structures. By making the entire database or large sections of the database inaccessible, modification of the lookup data structures can be prohibitively expensive. To solve this problem, lookup data structures may be oversized or over-engineered to handle higher throughput and more diverse lookup operations than needed.

Hash tables may have a pre-defined number of hash buckets available for data processing. Whether the hash tables are oversized or not, once data is added or changed, the data may no longer efficiently use the available hash buckets. Several data items may be referenced by the same hash bucket, and access to the data items may be limited such that further time to process requests is needed as only one request may access a hash bucket at a time.

A hash table may be oversized, with more buckets or indexes than currently expected to be needed. Oversizing the hash table leads to wasted memory and slower processing times. The hash table may be statically resized by freezing the system and/or shutting down the system. Shutting down the system is non-optimal and would lead to data being inaccessible to requests or greater load being put on other systems where the data may be accessed.

### BRIEF SUMMARY

Systems, methods and computer-readable media are provided for resizing an array by creating a new storage unit that references a previous storage unit referencing resources. When a request for a resource is received for a resource mapping on to the new storage unit, a latch is used to remove a first resource mapping for the resource from the first storage unit and add a second resource mapping for the resource to the new storage unit before releasing the latch on the first storage unit.

In one embodiment, a computer-implemented method includes determining that one or more conditions have been satisfied for resizing at least a first storage unit of a hash table and creating a second storage unit for the hash table. Using one or more references, the first storage unit is referenced from the second storage unit and a hash table header is updated to enable both the first storage unit and the second storage unit for routing new hash table requests. When receiving a request for a particular resource, it is determined that the particular resource maps to the second storage unit and previously mapped to the first storage unit. The first storage unit is identified based at least in part on at least one of the one or more references of the second storage unit. The computer-implemented method also includes acquiring a latch on the first storage unit, using the acquired latch to remove a first resource mapping for the particular resource from the first storage unit, adding a second resource mapping for the particular resource to the second storage unit, and releasing the latch on the first storage unit.

In a further embodiment, the request for the particular resource is a first request for the particular resource. The computer-implemented method may also include receiving a second request for the particular resource and, based at least in part on the second request, accessing the second storage unit to determine a status associated with the particular resource.

In a further embodiment, the computer-implemented method also includes receiving a second request for the particular resource and, based at least in part on the second request, accessing the second storage unit to add an entry based on the second request to a queue of one or more locks reserved for the particular resource.

In a further embodiment, the determining that the particular resource maps to the second storage unit and previously mapped to the first storage unit includes applying a hashing algorithm to a resource name of the particular resource, the hashing algorithm determining an identifier used to navigate to the particular resource.

In a further embodiment, the first storage unit and the second storage unit are parent storage units and the identifier used to navigate to the particular resource is unique to a data structure referenced by the second storage unit. The determining that the particular resource maps to the second storage unit and previously mapped to the first storage unit may include dividing the identifier by the number of child storage units within a parent storage unit to determine that the particular resource maps to the second storage unit.

In a further embodiment, the first storage unit and the second storage unit are parent storage units and the determining that the particular resource maps to the second storage unit and previously mapped to the first storage unit may also include applying a modulo operator to the identifier and the number of child storage units within a parent storage unit to determine the particular data structure of the second storage unit that the particular resource maps to.

In a further embodiment, the second storage unit may be ordered between the first storage unit and a third storage unit. Each of the first storage unit, the second storage unit, and the third storage unit may be associated with one or more numerical identifiers. The one or more numerical identifiers for each of the one or more data structures may be in ascending numerical order from the first storage unit to the third storage unit.

In a further embodiment, the request for the particular resource may be a first request for the particular resource. The computer-implemented method may also include receiving a second request for the particular resource, applying a hashing algorithm to a resource name of the particular resource to receive a hash value and applying a conversion table to the hash value to receive a modified hash value. The conversion table may alter the hash value based on the order of the first storage unit, the second storage unit, and the third storage unit. Based at least on the hash value, it may be determined that the particular resource maps to the second storage unit after which the particular resource may be accessed.

In a further embodiment, the one or more conditions include a metric of access to the first storage unit being above a threshold value.

In a further embodiment, the computer-implemented method also includes determining that one or more second conditions have been satisfied for resizing the hash table, determining that a minimum time has not elapsed since the creating the second storage unit, and blocking a resize process based at least in part on the determination that a minimum time has not elapsed.

In a further embodiment, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for resizing an array.

FIG. 2 illustrates a system diagram showing an example cloud infrastructure for managing an array.

FIG. 3 illustrates a diagram of an example user interface for depicting metrics of resource usage and displaying settings for managing an array.

FIG. 4 illustrates a diagram of the organization of storage units of an array throughout resized incarnations of the array.

FIG. 5 illustrates a diagram showing the structure of an array managed by a hash table header.

FIG. 6 illustrates a diagram showing the structure of an array after a resizing of the array.

FIG. 7 illustrates a diagram showing the structure of an array after a resource is moved to a newly created storage unit of the array.

FIG. 8 depicts a simplified diagram of a distributed system for implementing certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

### DETAILED DESCRIPTION

In various embodiments, resizing an array is performed by creating a new storage unit, such as a new hash bucket, that references a previous storage unit, such as a previous hash bucket, containing references to resources. When a request for a resource is received for a resource mapping to the new storage unit, a latch is used to remove a first resource mapping for the resource from the first storage unit and add a second resource mapping for the resource to the new storage unit before releasing the latch on the first storage unit.

In various embodiments, management of an array is implemented using non-transitory computer-readable storage media to store instructions which, when executed by one or more processors of a computer system, cause processing of the received input to manage an array. The management of an array may be implemented on a local or cloud-based computer system that includes processors and optionally a display showing a user interface to a user for array use or management. The computer system may communicate with client computer systems for array management.

A description of array management is provided in the following sections:
DATABASE RESOURCES REFERENCED BY ARRAYS
SEARCHING FOR A RESOURCE WITHIN AN ARRAY
TRIGGERING A RESIZE OF AN ARRAY
RESIZING OF AN ARRAY
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Database Resources Referenced by Arrays

A database may contain a plurality of resources stored and maintained in database structures or portions thereof. The resources are data items, records, or collections that can be stored in corresponding database structures as managed by a database system. The items the resources represent may be objects to be accessed by the database system when a request is generated by a program or a user as a client of the database system. A request may be to access, determine a status of, or edit a resource. Although resources are stored in underlying database structures, lookup metadata such as information about locks for the resources or storage addresses of the resources may be managed within an array, other lookup data structure, or other logical arrangement as a resource lookup mechanism. When resources are accessed to retrieve data of the resource, to edit the resource, or otherwise alter the resource, the resource lookup mechanism may be used to determine the lookup metadata about the locks or storage addresses. The storage addresses may indicate where underlying data for the resource is stored on disk or otherwise in a logical storage layer. Underlying data for some resources may be changed, but the resources may have a persistent name and type such that access to the resource by programs or users may be performed reliably. Even a name and type of the resource may be changed, but such change may also involve changing a resulting mapping for the resource in access pathway to the resource via the resource lookup mechanism if the resource name is used as input to the resource lookup mechanism.

To facilitate access to resources of the database, resources may be chained off an efficient resource lookup mechanism such as a hash table. A hash table is a lookup data structure that allows for efficient access of data by using a hashing algorithm to convert keys into a reference to an array of data. A reference may be any type of data used to identify a location of another piece of data or data structure such as a pointer. A hash table facilitates access to a pre-defined number of items within an array, such as an array of a set size. When using the hashing algorithm with a key, the key is said to be “hashed” into the reference value that is output by the hashing algorithm. When implemented to access resources via the array of the hash table, the hashing algorithm is constructed such that for any key entered, the hashing algorithm will return a consistent reference to one item of the array for that key that may be consistent regardless of when the key is hashed using the hashing algorithm.

A hashing algorithm may use one-way or two-way hashing. A one-way hashing algorithm may output a hash value which cannot be reverted into the original value of the key entered. A two-way hashing algorithm may output a hash value which can be reverted into the original value of the key entered, such as reversing an encryption algorithm. Either type of hashing algorithm may be used, however, one-way hashing algorithms may provide the advantage of more easily providing a hash value for each key entered, and therefore may account for a greater number of resources managed by the hash table.

The array includes one or more items. Each item of the array comprises a storage unit for storing metadata including at least a reference to a data structure containing the underlying data of a resource. The storage unit may be configured for storing metadata, for example by being of a size of bits on a storage device or memory necessary for storing at least a pointer or other reference to a data structure. In one embodiment, the items of the array may include a parent storage unit or segment which contains one or more child storage units or buckets, where the child storage units may contain zero or more references to zero or more data structures containing underlying data of a resource. The storage units may be referred to as “buckets” of the array, “lookup metadata storage units” that store lookup metadata, or child storage units of a segment of the array. The segments of the array may be also referred to as storage units that contain other storage units, parent storage units, or, alternatively, “bucket segments.”

The hash table may control access to a plurality of buckets of an array, of which there is a pre-determined number of buckets available at the time of instantiating the hashing algorithm and hash table. To solve collisions of the hashing algorithm, where the hashing algorithm hashes to the same bucket for input keys of different resources, the buckets of the array may each contain a number of references to resources chained off the bucket. A bucket may contain one or more references to one or more data structures containing the resources that the hashing algorithm hashes to that bucket. The one or more references to one or more data structures may be stored in the bucket as a linked list to preserve a size and location offset for the corresponding bucket entry. A bucket may contain lookup metadata such as locks, logical storage locations, or physical storage locations, other metadata, or some or all of the actual data of the resource that the hashing algorithm hashes to that bucket for efficient lookup based on the resource name or other resource identifier.

To further facilitate efficient access of data, buckets may be grouped into one or more bucket segments. The hash table may direct incoming requests to one or more bucket segments to satisfy the requests. Each bucket segment may be a structure or representation of a subset of buckets that are connected such that access to the bucket segment permits access to each of the associated buckets in the subset. Further, bucket segments may be modified separately such that a modification of one bucket segment does not impact another bucket segment.

A resource may be chained off a bucket in that the bucket stores a reference to the resource in a chain of one or more resource references where each preceding resource reference of the chain of resource references contains a reference to a subsequent resource reference of the chain of resource references. When a bucket contains more than one reference to more than one resource, the references to the resources may be chained such that a first resource reference of the chain may reference a second resource reference of the chain. In this way, the resources mapped to a bucket may be traversed by accessing successive resource references maintained for the bucket. A resource may be said to be chained off a bucket if a reference for the resource exists either within the bucket or within one of the other resource references of the chain of resource references off the bucket.

The hash table may control access to the plurality of buckets via the hashing algorithm. The hashing algorithm receives a key as an input, where the key is associated with a specific resource such as a resource identifier. The hashing algorithm is performed on the key input, and a hash value is output. The output hash value references the bucket segment where the reference to the resource may be found. A further output or extension of the hash value may reference the bucket within the segment where the reference to the resource is found.

When a resource is first requested, the resource name may be used as a key input for the hashing algorithm. The hashing algorithm outputs a hash value that references a bucket segment where the reference to the resource is to be found. The bucket segment may then be accessed, and the correct bucket of the bucket segment may be determined from the hash value output. The bucket may then be accessed, at which point the system may determine whether the bucket contains an existing reference for the requested resource. If the requested resource does not exist within the chain of resources off the bucket, the system may obtain a reference for the requested resource which may be added to the bucket or the last resource of the resource chain of the bucket.

### Searching for a Reference to a Resource Within an Array

When searching for a reference to a specific resource, a user may have a resource request with a name or other identifier of a resource. In one example, the resource name is hashed as the key for the hashing algorithm to reference the correct bucket segment. In order to hash the resource name, a numeric representation of the resource name may be manipulated by numerical operations to result in an output hash value. The hash value output by the hashing algorithm may indicate the bucket segment and/or the bucket in which a reference to the resource may be found. For example, the hash value may be an index of or reference to a bucket from the array of buckets. The hash value may be used to navigate the array of buckets to determine the correct bucket indicated by the hash value.

The bucket segment comprises one or more buckets which may each contain a number of references to a number of resources, among them being the requested resource. The bucket segment may be searched by stepping through the resource references of the buckets of the bucket segment to find the requested resource. Alternatively, if the hash value indicates a bucket of the bucket segment, the bucket designated to contain the reference to the resource may be accessed directly. When selecting a bucket to search for the resource reference, a resource chain hanging off the bucket may be searched or otherwise traversed to determine if the reference to the resource is within the bucket.

In one example, the hash value indicating the bucket segment and/or bucket may be a bucket ID. A bucket ID may be assigned to each bucket of the bucket segments, with the number of bucket IDs being persistent across buckets of the bucket segments. When hashing a resource name into the bucket ID, the resource name may comprise one or more resource IDs and other optional metadata. The database management system first determines which parts of the resource name to use, such as specific IDs of the resource name. The components of the resource name may be numeric values. The components of the resource name are manipulated by the hashing algorithm by numerical operations on the value of the components of the resource name such that each time a given resource name is used with the hashing algorithm, the hashing algorithm outputs a consistent bucket ID for the resource, such as a value between zero and the current total number of buckets.

In one example, a database may contain a hash table header, such as a segment array header, pointing to a first and a second bucket segment, each with four buckets. The user may make a request for a resource with name “[AB][0x1234]” which is then hashed into a bucket ID between 0 and 7 as there are eight buckets with numbering starting at 0. The bucket may be determined from this bucket ID with knowledge of the number of buckets per bucket segment. For example, the bucket ID may be divided by the number of buckets per bucket segment and rounded down to give a value indicating which bucket segment houses the bucket of the bucket ID. For this example, if the bucket ID of 6 was hashed, then the bucket ID (6) may be divided by the number of buckets per segment (4) and rounded down to give a value of 1, indicating that the second bucket segment contains the bucket of bucket ID 6. In this way, the bucket segment containing the bucket with the resource may be determined using only the bucket ID and knowledge of the structure of the bucket segments. The specific bucket within the second bucket segment may be determined by performing a modulo operation between the bucket ID and the number of buckets per bucket segment. This gives a value of 2, indicating that the third bucket of the bucket segment is the bucket with bucket ID 6. In this way, the bucket with the resource may be determined using the bucket ID and knowledge of the structure of the bucket segments when the correct bucket segment has been determined.

For each bucket, the first resource reference may be accessed and checked to determine if the first resource reference is for the requested resource. If a reference to the requested resource has not been found, a subsequent resource reference of the resource chain, directed to by the current resource reference, may be accessed and checked to determine if it is the requested resource reference. When a current resource reference checked is the last resource reference on a resource chain, the bucket segment may be accessed again to check the next bucket in the bucket segment. If the current resource reference is not listed in the resource chain, the current resource reference may be added to the end of the resource chain.

When accessing a reference to any resource of a bucket, a latch may be taken on the bucket representing the resources. The latch restricts access to the contents of bucket while the request for the bucket contents is processed. For example, the bucket contents may change while the latch is being held, and a next process to access the bucket would see the contents as changed instead of the contents in the process of being changed. The latch may be a global setting for access to the bucket, which indicates to subsequent requests that the bucket is in use and may not currently be accessed. A latch is taken in order to prevent the altering of references within the bucket while the bucket is being searched or otherwise processed to make decisions based on those references.

In one embodiment, any given resource may have a chain of locks attached to the given resource, and the chain of locks may be managed from the bucket corresponding to the resource. The chain of locks may be a structure potentially containing locks registering the current use of a resource and restricting access to the resource until the current lock is removed when the current user of the resource has stopped using the resource. When a reference to the requested resource is found within the chain of resource references off a bucket, the chain of locks attached to that resource is searched to determine if a current lock exists from a different request. If so, the current request may be paused until the lock is removed on the requested resource. A subsequent lock on the resource may be added to the end of the chain of locks such that the request may be processed in order of the chain of locks and the current request may be processed after prior locks are removed, such that the current request may become the current lock and efficiently un-pause when the resource is available. If no lock exists within the chain of locks, a lock is taken on the requested resource by adding the lock to the front of the chain of locks, and the requested resource may be accessed using the lock for completing the request.

Locks may be accessed by a reference contained within the resource data, within metadata about the resource, or by accessing a separate data structure for locks defined by a hash table. A chain of locks may be attached to a resource by defining a data structure that may contain one or more locks and storing the chain of locks within the resource data. Alternatively, the chain of locks may be a separate data structure stored in a different location from the resources the chain describes, and a reference to the data structure of the chain of locks may be added to the resource or metadata for the resource to control access to the resource.

A chain of locks may be referenced by a refence stored within a bucket of a same or separate hash table. The locks hash table may utilize the same or a different hashing algorithm, however, the hashing algorithm for the locks hash table may still use the same key as the resource hash table, such as the resource name. The locks hash table may output a reference to a bucket which contains the chain of locks for a given resource or a reference to the data structure containing the chain of locks for a given resource. In some embodiments, the chain of locks may contain a reference to the resource such that the reference is used to access the resource whenever the process in question has the current first lock of the chain of locks. In this way, the locks hash table may be used as the managing hash table for the resources.

### Triggering a Resize of an Array

If the number of resources represented on a resource chain within one bucket grows too large, then searches through that bucket will become cumbersome. Multiple resources being represented on a resource chain within one bucket also means that processing requests to access those resources within the chain will be delayed as requests take a latch on the entire bucket, preventing a resource from accessing its intended target resource even if that resource is not being utilized by the process that currently has the latch on the bucket. A default value for a maximum number of resources for a single bucket may be a number beyond three, four, five, six, seven, or eight resources or any other threshold number of resources off a single bucket. For example, this threshold determines how many hash table collisions are tolerable before hash table resizing should be initiated. If the total number of resources of a bucket is too large, then a new set of buckets may need to be created to manage the resource lookup metadata. To address these issues the array may be resized to create more buckets for storing references to resources, but resizing a structure used for resource lookup may impede or freeze lookup on any resources represented in the structure. Such freezing of processes may be intolerable for high throughput systems, but high throughput and high volume systems are also most likely to have hash table collisions.

The resizing of an array may be triggered by a resource usage statistics monitoring process. The monitoring process may trigger a resize of the array when certain pre-determined rules are met. For example, a pre-determined rule may specify a frequency of accesses to a bucket being postponed due to an existing latch on a given bucket. When a pre-determined number of the buckets of the array reach a pre-determined frequency of postponed accesses then the resizing is triggered. In another example, a resizing may be triggered due to a collective access frequency of the resources on a resource chain of a given bucket being above a pre-determined threshold. In another example, a resizing may be triggered due to one or more buckets having above a threshold number of processes in a queue for accessing a bucket that currently has a latch. In yet another example, a resizing may be triggered due to one or more of the buckets having greater than a threshold number of resources represented on or added to the chain of the bucket.

The database management system may output resource usage metrics such as in a display to a user to aid in management of the database, or as a record to be processed automatically by the database system. The usage metrics may include the current calculated value and the pre-determined threshold value for any of the pre-determined rules for resizing. The current calculated values may be compared to the pre-determined threshold values. Other metrics may be included to give further context to a metric such as individual usage metrics for resources within a chain of resources where a total usage metric is depicted for the chain of resources. Metrics and metric data may be saved such that metrics may be added over time. Previous metric data prior to a resizing may be compared to current metric data such that the database system or database administrator user may determine if the database management system is properly utilizing resizing for performance benefits or if modification of the automated rules for triggering resizing may be needed.

The hash table header, such as a segment array header, may specify a resize time. The resize time may be a minimum amount of time between resizes such that the database management system does not resize multiple times consecutively. The minimum amount of time provides time to process some requests and begin to move resources to the new buckets created before making another decision based on a small sample or otherwise too quickly after an initial resizing. The resize time may specify an amount of time, in which case, when resizing an array, the clock time at the time of resizing may be recorded in association with the resize time. When the database management system makes a determination that the array should be resized, the database management system will check for the resize time and compare the recorded time of resizing to the current time to determine if the minimum resizing time has elapsed. Alternatively, a timer may be created to actively track the time beginning at the time of resizing. The timer may be compared to the resize time to determine if resizing is permitted when the database management system determines that resizing may be necessary. When implementing a timer, the timer may trigger, upon reaching the minimum resizing time, a new analysis based on updated resource usage metrics to determine if resizing is necessary.

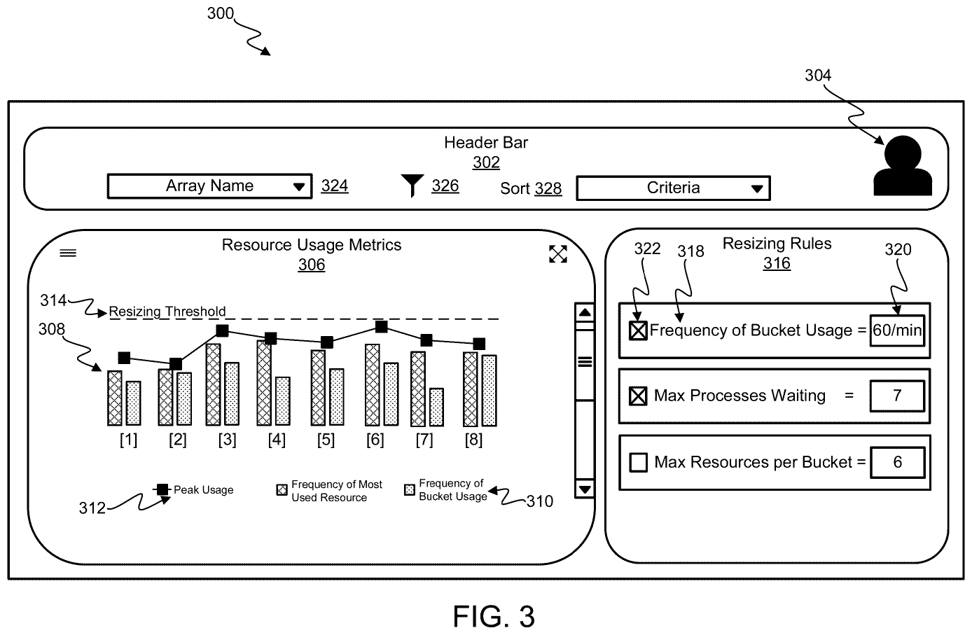

FIG. 3 depicts an example user interface 300 for managing an array. The user interface may have a first region 302 containing settings for the display of metrics and settings for arrays. The user interface 300 may recognize a user 304 via a set of user credentials which control access to the arrays to be displayed or the ability to alter settings for arrays. The user interface 300 may include a region for displaying resource usage metrics 306. The example display in the example user interface 300 depicts a graph of usage metrics 308. The graph of usage metrics 308 displays both metrics of usage 310 and metrics giving context to usage metrics 312. For example, the usage metric 308 may be a combined frequency of usage of the resources in a resource chain of a given bucket or the frequency of the most used resource in a resource chain of a given bucket. An example metric giving context to usage metrics 312 may be a highest recorded usage frequency for a given time range. The graph 308 may be displayed with additional context such as an indication of a threshold 314 for determining when resizing may occur. The user interface 300 may also contain a region for displaying rules for determining resizing 316. The resizing rules region 316 may contain a plurality of candidate rules, each comprising a logical statement or operator 318, a value for determining a threshold 320, and a toggle setting 322 for determining whether the rule is active. The user interface 300 may also contain one or more settings for controlling the user interface 324-328. For example, a setting for selecting an array 324 may control the array for which metrics and rules are currently displayed in the user interface 300. The selection of arrays to control may be restricted for the user 304 based on their user credentials. A setting for filtering views 326 may allow a user to restrict the views available by certain criteria such as to limit the metrics displayed. Another setting for sorting displayed elements 328 may permit a user to alter the order in which elements of the user interface 300 are displayed, such as to display currently active resizing rules at the top of the list of resizing rules.

### Resizing of an Array

To resize the array, a new hash table header or segment array header is created, and new buckets are generated to expand the available storage units for storing references to resources. The new header is created with a new hashing algorithm that is expanded to include more possible resources and more possible endpoints within the expanded list of buckets available. The new header still produces a reference for previous resources stored in previous buckets such that resources stay defined within the system. The new header contains references for all current buckets, including the previous buckets and the newly generated buckets.

When resizing the hash table, a number of new buckets or bucket segments may be created equal to the number of previous buckets or bucket segments such that the number of buckets or bucket segments after resizing is larger than (e.g., twice or four times) the previous number of buckets or bucket segments. When creating a number of new buckets or bucket segments, space is allocated for each of the new buckets. The new buckets may each be assigned a hash value that will be used to locate that bucket when using the hash algorithm. The hash values may be assigned in order beginning at a next proceeding value after the previous highest value for previous buckets. When creating a number of new bucket segments, a number of new buckets equal to the number of buckets for each bucket segment may be created. In some embodiments, a bucket identifier or storage unit identifier may be created and stored for each of the new buckets created, and the new hashing algorithm may be modified to map inputs onto the new set of bucket identifiers.

In one example, an additional number of new buckets may be created such that each previous bucket maps one-to-one with a new bucket and such that there is an additional bucket for each previous bucket. The new buckets may be generated such that they map one-to-one with previous buckets so that every bucket has a new bucket for moving resources to. In this way, in one embodiment, the number of buckets may be the number of buckets at the first iterations of the hash table multiplied by two to the power of the number of iterations of resizing the hash table so far. For example, the hash table may have begun with two thousand buckets, in which case the hash table would have four thousand buckets upon the first resizing, eight thousand buckets upon the second resizing, and so on. When new buckets are generated in resizing the hash table, each new bucket may contain a reference to a previous bucket that the new bucket may accept migrated resources from.

For embodiments using bucket IDs as hash values, a number of bucket IDs corresponding to an incarnation number may be mapped to across different incarnations of the segment array header such that previous or active requests that have retrieved a bucket ID are not interrupted by a resize of the array, and new requests using a new incarnation may map to a same or different bucket ID even for the same inputs as the previous or active requests. New buckets added in a resizing may be assigned sequential bucket IDs that follow the highest previous bucket ID number. The hashing algorithm is reconfigured to hash to either the previous bucket or a new bucket immediately following the previous bucket. In this way, resources may be maintained in the same order after the resizing.

To generate the new hash value for a resource name, a binary branching method may be used. The bucket ID returned by the original hashing algorithm is obtained and a new bitstring is added to the end with an additional bit representing the branching of each resize incarnation. The additional bit is determined from a hashing algorithm using a subset of data from the resource name or other resource identifier input, where the original hashing algorithm may have determined an original bucket identifier based on a superset of data from the resource name or other resource identifier input or based on a different subset of data from the resource name or other resource identifier input. The additional bit added to the bitstring for each resize incarnation may be either a 1 or a 0. By using the original hash algorithm or a different hash algorithm on a different subset of data than was used for the original hash algorithm, or by using a different hash algorithm on the same subset of data, the database management system deterministically approximately randomizes resource movement to move to the new bucket based on the newly determined bit. For subsequent resizes, a new bit at a different location or using a different subset of the resource name, or using a different hash algorithm, may be used to deterministically but approximately randomly determine movement of resources for that resizing. The original bucket ID in addition to the new bitstring is the total hash value output for each incarnation of the hashing algorithm. New bitstrings may be added on iteratively for each new incarnation, with a previous incarnation forming the portion being appended to.

When indexing into the buckets of a pair of a previous bucket and a new bucket, the precious bucket may be represented by bucket IDs ending with a 0 in the new digit and the new bucket may be represented by bucket IDs ending with a 1 in the new digit. This may be repeated for each resizing, taking the previous bucket ID of the hashing algorithm plus any additional bits from previous resizes. Therefore for n number of resizes, n number of digits may be added to the bucket ID to traverse to the correct bucket segment containing the bucket.

As resources are mapped within the new segment array header, after generation of the new segment array header and the new buckets and after the mapping of the new buckets to the previous buckets, the new segment array header may be used for directing requests as requests may be routed from the new segment array header either to the previous buckets, to the new buckets, or to the previous buckets via the link from the new buckets. A setting may be changed such that resource requests are directed to the new segment array header. Once all new requests are routed to the new segment array header, the previous segment array header may no longer be used and may be deleted.

With each new incarnation of the segment array header, the new buckets may be ordered such that the references to resources stored within the buckets maintain the same relative organization. This may be done so that operations iterating through the buckets will still be able to traverse the resources in the same order as expected before the resize. For embodiments using a bucket ID as the hash value, a conversion table may be required to convert the output of a calculation to determine the bucket segment into the proper bucket segment. The calculation of dividing the bucket ID by the number of buckets or other storage units per segment outputs a value that orders the bucket segments in order they were created. This value may be altered by a conversion table to point to the bucket segment in the order in which they exist after resizing. Alternatively, the conversion table may instead store the bucket ID of the first bucket of the correct bucket segment so that lookup of the bucket is made faster by reducing the number of operations to perform.

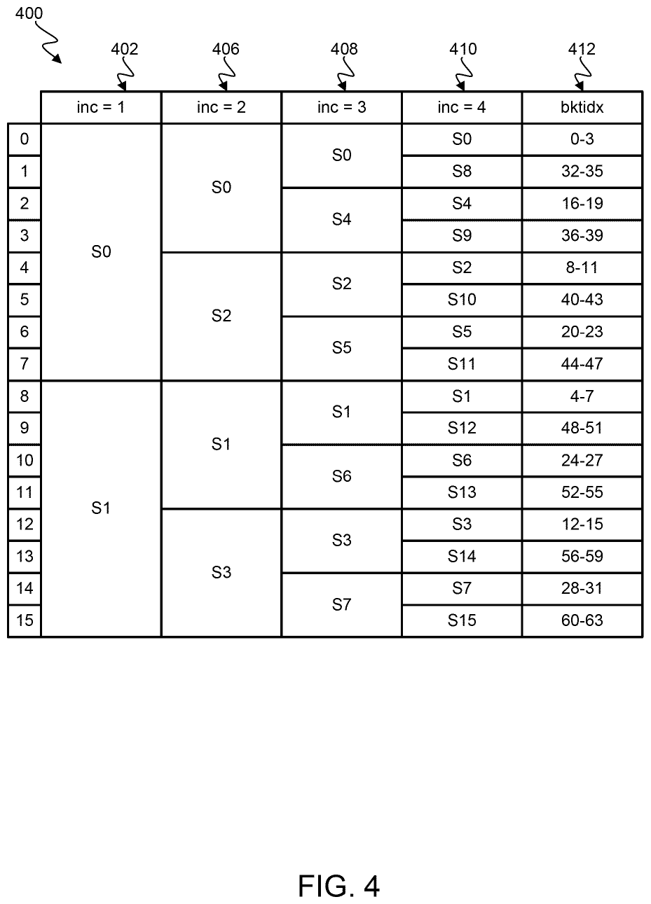

FIG. 4 depicts a graph 400 indicating an example of how storage units may be arranged for each incarnation of the resized hash table header. In the example, the first incarnation 402 depicts a set of two parent storage units S0 and S1. The second incarnation 406 depicts double the number of parent storage units as the previous incarnation, with S2 and S3 being added. Parent storage unit S2 is added between S0 and S1 such that S2 may take on resources originally in S0 so as to maintain their organizational relationship before resources of S1. Incarnations 408 and 410 again depict twice as many parent storage units as their previous incarnation, with new parent storage units added immediately after each previous parent storage unit. A bucket ID 412 is indicated for each child storage unit of the parent storage units. As depicted, the bucket ID 412 for each child storage unit sequentially increases with time of storage unit creations, however the bucket ID values, when viewed in order from top to bottom, are alternating based on the incarnation those child storage units were created in. As this depicts the bucket IDs for a fourth incarnation 410, bucket IDs for child storage units of the parent storage units created in the fourth incarnation 410 alternate with previous child storage units of previous incarnations.

Within the new hashing algorithm, some resources that were previously referenced in a previous bucket may map onto a new bucket of a new bucket segment such that applying the hashing algorithm to the key of the resources in question results in a reference to a new bucket. If the resource is not yet moved to the new bucket, when the database management system receives a request for that resource, the hashing algorithm will point to the new bucket segment as having the storage unit for the resource. Upon checking the new bucket segment, the database management system may determine that the bucket is the intended place for the resource, but that the resource has not been moved yet. The database management system may optionally take a latch on the bucket while the resource is retrieved, which may be taken with no wait as no other process has yet accessed the resource via the new bucket. The database management system may follow the reference included in the new bucket to the previous bucket that still contains the resource. A latch may be taken on the bucket and the resource may be found by searching the chain of resources on the bucket. Alternatively the determination that the resource should be moved may be made by determining at the point of accessing the resource that the resource was accessed via another bucket, which should instead contain the resource. The resource may then be moved to the new bucket by adding the resource to the new bucket and removing the resource from the previous bucket. The latch may then be released on the previous bucket and the resource may be accessed from the new bucket. The resource within the new bucket may be accessed by taking a lock on the resource and removing any lock on the new bucket.

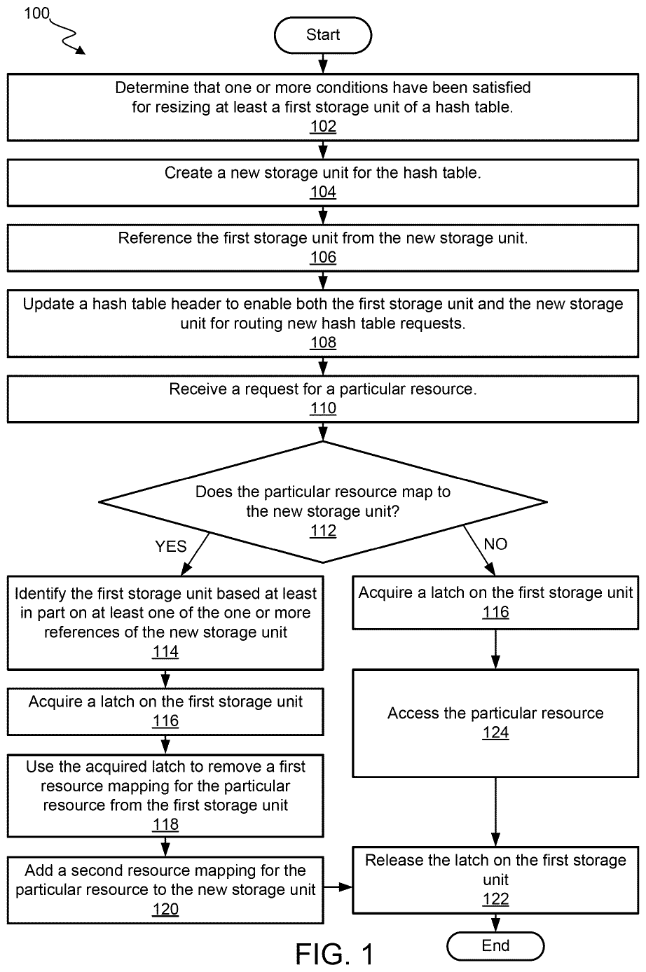

FIG. 1 depicts a flow chart 100 of an example process for resizing database structures. At block 102, a database management system determines that one or more conditions have been satisfied for resizing at least a first storage unit of a hash table. The conditions may be dependent on usage metrics of the first storage unit of the hash table. After triggering resizing, at block 104, a new storage unit is created for the hash table. Creation of a new storage unit may be part of a process of generating a new set of storage units, including the new storage unit, and generating a new hashing algorithm that maintains the same output value for resources to the previous storage units. To associate the new storage unit with the first storage unit as a resize of the first storage unit, at block 106, the first storage unit is referenced using one or more references from the new storage unit. At block 108, a hash table header is updated to enable both the first storage unit and the new storage unit for routing new hash table requests. At block 110, a new request for a particular resource is received. At block 112, the mapping of the particular resource is checked to determine if the particular resource maps to the new storage unit. If the particular resource is determined to map to the new storage unit and previously mapped to the first storage unit then, at block 114, the first storage unit is identified based at least in part on at least one of the one or more references of the new storage unit. At block 116, a latch is acquired on the first storage unit. At block 118, the acquired latch is used to remove a first resource mapping for the particular resource form the first storage unit. At block 120, a second resource mapping for the particular resource is added to the new storage unit, such that the particular resource stays defined. After adding a mapping for the particular resource, the latch is released on the first storage unit at block 122. If the particular resource is determined to map only to the first storage unit, then the process proceeds to block 116, and a latch is acquired on the first storage unit. The particular resource is accessed at block 124, and the latch on the first storage unit is removed at block 122. Either before removing the first resource mapping at block 118 or after adding the second resource mapping at block 120, the particular resource may be accessed to satisfy the request for the particular resource received at block 110.

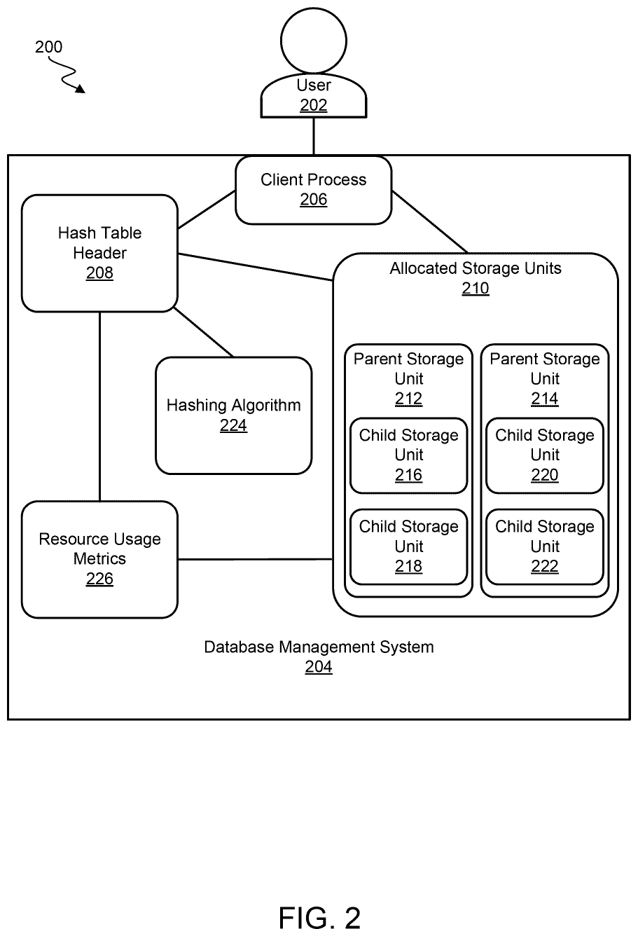

FIG. 2 depicts a database management system 200 for managing database structures. A user 202 interacts with a database management system 200 by accessing a client process 206. The client process 206 creates a request for a resource within the database. The request is transmitted to a database process for analyzing a hash table header 208. The hash table header 208 contains a set of references for allocated storage units 210. The allocated storage units 210 contains a plurality of parent storage units 212-214. The parent storage units 212-214 contains a plurality of child storage units 216-222 which each contain references to zero or more resources. When a request for a resource is received, the request is hashed using a hashing algorithm 224 which designates a storage unit for the resource of the request. The allocated storage units 210 are accessed via a reference of the hash table header 208 and the resource may be found within one of the child storage units 216-222 of the parent storage units 212-214. The database management system 204 also stores resource usage metrics 226 which may be compared to resizing settings within the hash table header 208 to determine when the allocated storage units 210 should be resized and the hashing algorithm 224 be modified.

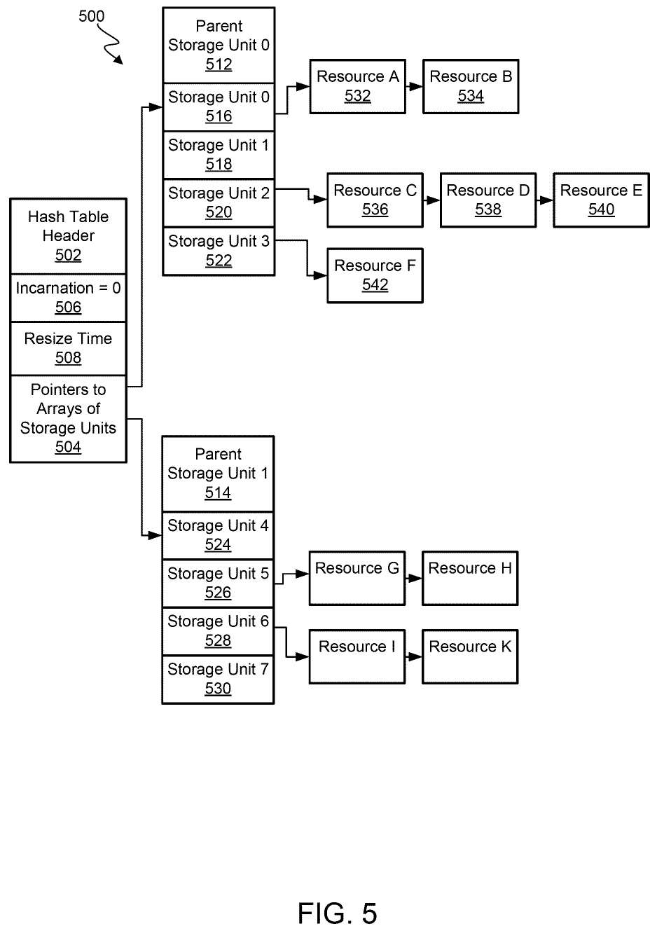

In a particular example, FIG. 5 depicts a data storage system 500 managed by a hash table header 502. The hash table header 502 includes a number of references 504 to arrays of storage units. The hash table header is currently used for navigating to the storage units via the references to arrays of storage units 504 as it is the current incarnation of the hash table header 502. The current incarnation of the header may be determined by comparing an incarnation value 506 of one or more hash table headers. The hash table header 502 may also contain a setting for determining resizing 508 such as a resize time. The resize time may set a current limit on when the hash table header 502 should be resized to a new incarnation.

The references to arrays of storage units 504 may point to one or more parent storage units 512-514. A first parent storage unit 512 may contain a first plurality of storage units 516-522 and a second parent storage unit 514 may contain a second plurality of storage units 524-530. The storage units of the first parent storage unit 512 may contain references to a plurality of resources 532-542. The references to the plurality of resources 532-542 may be arranged in one or more chains off the storage units of the first parent storage unit 512. For example, a reference to resource A 532 hangs off a storage unit 516 in a chain with a reference to a subsequent resource B 534 attached to the reference to resource A 532 in the same chain. In some examples, a chain may contain only one resource reference, such as resource reference F 542, which is the only resource reference in the chain hanging off storage unit 3 522. Resource reference C 536, resource reference D 538, and resource reference E 540 are in a chain off of storage unit 2 520. The data storage system 500 may detect from the usage statistics of the resources of storage unit 2 520, that the storage unit represents too many resources, and the hash table needs to be resized to accommodate moving the reference to resource E 540.

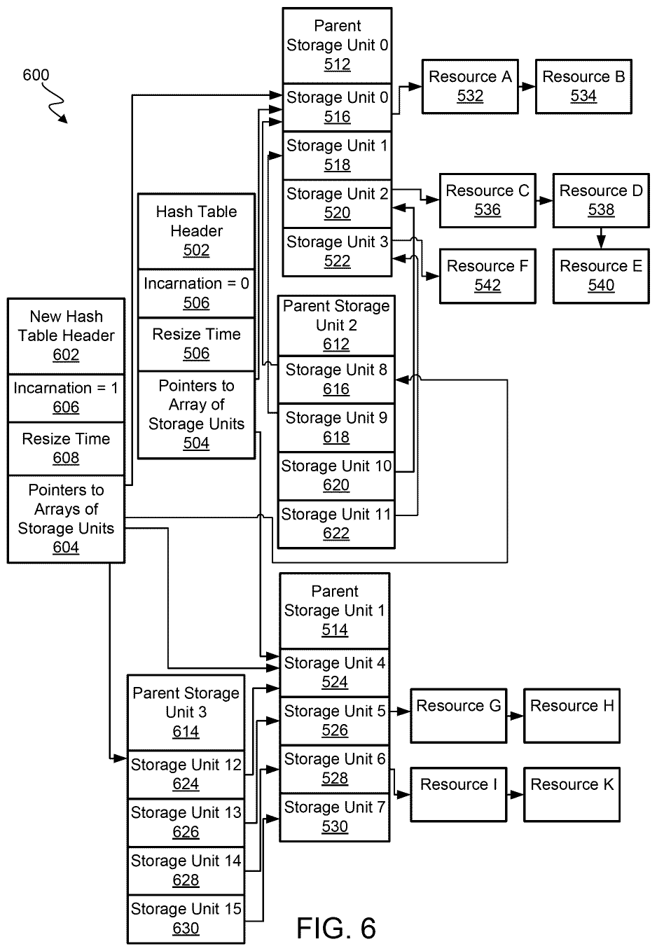

FIG. 6 depicts a data storage system 600 after a resize has been performed on the data storage system 500 and the array is now managed by a new hash table header 602. The new hash table header 602 may also contain its own references to arrays of storage units 604, incarnation number 606, setting for determining resizing 608, and set of flags 610. The new hash table header 602 contains references to arrays of storage units 604 that include references to the previous parent storage units 512-514 and to an equal number of new parent storage units 612-614. The number of parent storage units, and thus child storage units, at the current incarnation is the number at the first incarnation multiplied by 2 to the power of the incarnation number 606. After resizing, the previous hash table header 502 still exists for directing ongoing requests received during the resizing process. At the time of resizing, the new storage units 616-630 contain a pointer or other reference to a corresponding storage unit of the previous parent storage units 512-514.

When a request is received for resource E 540, the request is hashed and to determine that resource E 540 maps to parent storage unit 2 612. A reference is followed to parent storage unit 2 612 and a latch is taken on storage unit 10 620 to search for a reference to resource E 540, however the representation of resource E 540 has not yet been moved to storage unit 10 620. A reference in storage unit 10 620 indicates that the reference to resource E 540 may be found in storage unit 2 520. The reference is followed and the reference to resource E 540 is found in storage unit 2 520. A latch may be taken on storage unit 2 520 while the reference to resource E 540 is removed from storage unit 2 520 and added to storage unit 10 620. The latches on both storage unit 2 520 and storage unit 10 620 may then be removed.

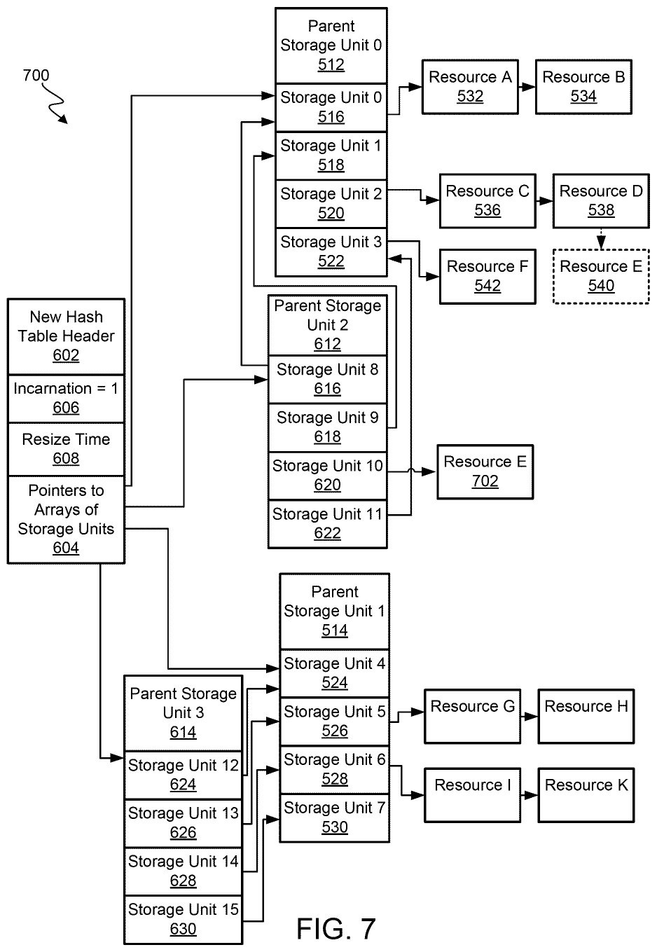

FIG. 7 depicts a data storage system 700 after a resize has been performed on the data storage system 500 and the reference to resource E 540 has been moved to one of the new parent storage units. The reference to resource E 540 is moved to storage unit 10 620 and is removed from the resource chain of storage unit 2 520. As parent storage units are accounted for within the references to arrays of storage units 604, the previous hash table header 502 may be deleted.

In some instances, when moving a resource reference between storage units after a resizing, a process may have already navigated to the previous storage unit via the hashing algorithm and checking the new storage unit's reference, however the process is waiting on a process which currently has a latch on the previous storage unit while the resource is moved. For these subsequent processes that are waiting on the latch, the resource will no longer be available at the storage unit they are waiting on the latch for. To resolve this, when accessing a resource reference at a storage unit other than the first storage unit designated by the hash value, the process will re-hash the resource name and check if the resource has already been moved before taking the latch on the previous storage unit to access the resource reference. If the resource reference has been moved, the new hash value is used, and the process attempts to take a latch on the new storage unit.

### Computer System Architecture

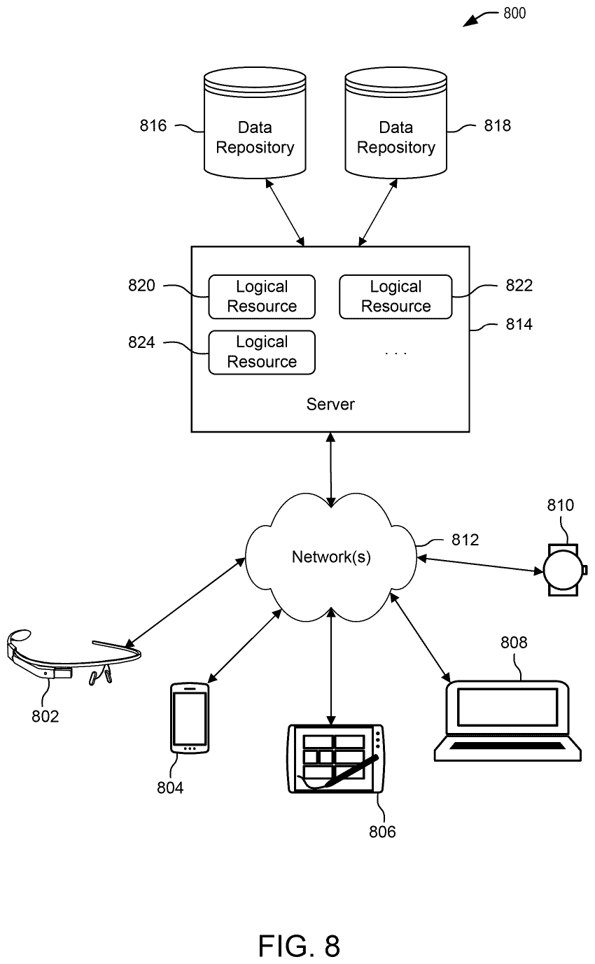

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for array management.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for array management in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 814 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for array management. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

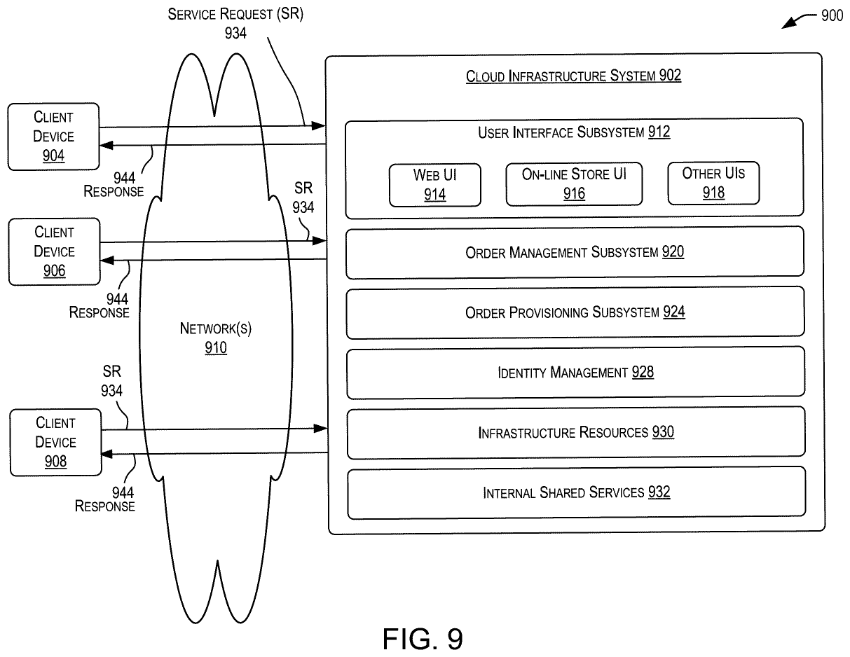

FIG. 9 is a simplified block diagram of a cloud-based system environment in which management of an array is executed, in accordance with certain aspects. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise an order management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the order provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

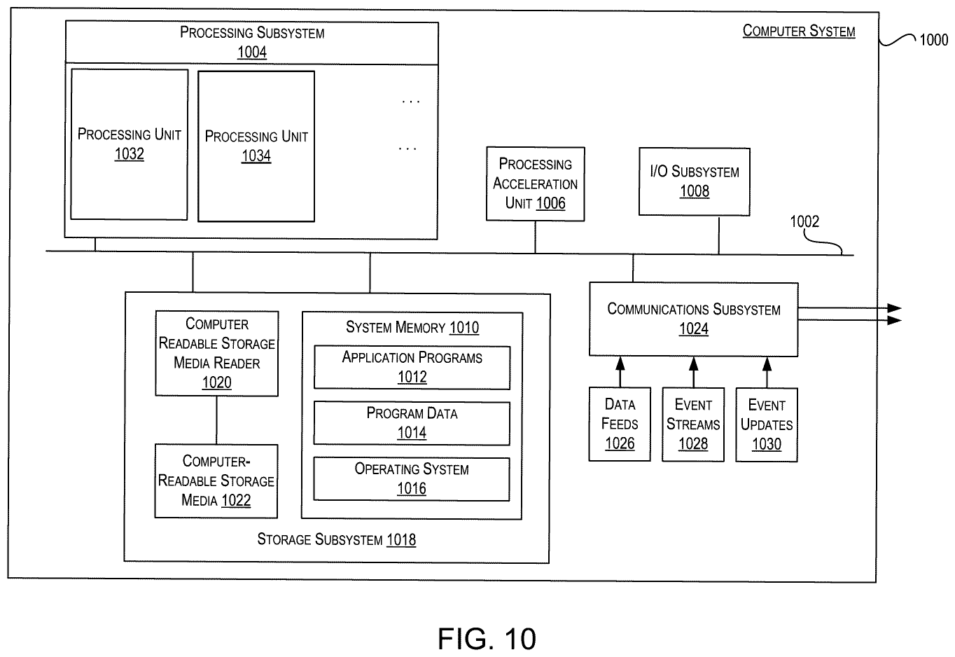

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
determining that one or more conditions have been satisfied for resizing at least a first storage unit of a hash table;
creating a second storage unit for the hash table;
referencing, using one or more references, the first storage unit from the second storage unit;
updating a hash table header to enable both the first storage unit and the second storage unit for routing new hash table requests;
receiving a request for a particular resource;
determining that the particular resource maps to the second storage unit and previously mapped to the first storage unit;
identifying the first storage unit based at least in part on at least one of the one or more references of the second storage unit;
acquiring a latch on the first storage unit;
using the acquired latch to remove a first resource mapping for the particular resource from the first storage unit;
adding a second resource mapping for the particular resource to the second storage unit; and
releasing the latch on the first storage unit.

2. The computer-implemented method of claim 1, wherein the request for the particular resource is a first request for the particular resource, and wherein the computer-implemented method further comprises:
receiving a second request for the particular resource; and
based at least in part on the second request, accessing the second storage unit to determine a status associated with the particular resource.

3. The computer-implemented method of claim 1, wherein the request for the particular resource is a first request for the particular resource, and wherein the computer-implemented method further comprises:
receiving a second request for the particular resource; and
based at least in part on the second request, accessing the second storage unit to add an entry based on the second request to a queue of one or more locks reserved for the particular resource.

4. The computer-implemented method of claim 1, wherein the determining that the particular resource maps to the second storage unit and previously mapped to the first storage unit comprises:
applying a hashing algorithm to a resource name of the particular resource, wherein the hashing algorithm determines an identifier used to navigate to the particular resource.

5. The computer-implemented method of claim 4, wherein the first storage unit and the second storage unit are parent storage units; wherein the identifier used to navigate to the particular resource is unique to a child storage unit in the second storage unit, and wherein the determining that the particular resource maps to the second storage unit and previously mapped to the first storage unit comprises:
dividing the identifier by a number of child storage units within a parent storage unit to determine that the particular resource maps to the second storage unit.

6. The computer-implemented method of claim 5, wherein the first storage unit and the second storage unit are parent storage units; wherein the determining that the particular resource maps to the second storage unit and previously mapped to the first storage unit comprises:
applying a modulo operator to the identifier and the number of child storage units within a parent storage unit to determine the particular child storage unit of the second storage unit that the particular resource maps to.

7. The computer-implemented method of claim 1, wherein the second storage unit is ordered between the first storage unit and a third storage unit,
wherein each of the first storage unit, the second storage unit, and the third storage units is associated with one or more numerical identifiers, and
wherein the one or more numerical identifier for each of the one or more data storage units is in ascending numerical order from the first storage unit to the third storage unit.

8. The computer-implemented method of claim 7, wherein the request for the particular resource is a first request for the particular resource, and wherein the computer-implemented method further comprises:
receiving a second request for the particular resource;
applying a hashing algorithm to a resource name of the particular resource to receive a hash value;
applying a conversion table to the hash value to receive a modified hash value, wherein the conversion table alters the hash value based on the order of the first storage unit, the second storage unit, and the third storage unit;
determining, based at least on the hash value, that the particular resource maps to the second storage unit; and
accessing the particular resource.

9. The computer-implemented method of claim 1, wherein the one or more conditions comprise a metric of access to the first storage unit being above a threshold value.

10. The computer-implemented method of claim 1, further comprising:
determining that one or more second conditions have been satisfied for resizing the hash table; and
determining that a minimum time has not elapsed since the creating the second storage unit; and
blocking a resize process based at least in part on the determining that the minimum time has not elapsed.

11. A computer-program product comprising one or more non-transitory machine-readable storage media, including stored instructions configured to cause a computing system to perform a set of actions including:
determining that one or more conditions have been satisfied for resizing at least a first storage unit of a hash table;
creating a second storage unit for the hash table;
referencing, using one or more references, the first storage unit from the second storage unit;
updating a hash table header to enable both the first storage unit and the second storage unit for routing new hash table requests;
receiving a request for a particular resource;
determining that the particular resource maps to the second storage unit and previously mapped to the first storage unit;
identifying the first storage unit based at least in part on at least one of the one or more references of the second storage unit;
acquiring a latch on the first storage unit;
using the acquired latch to remove a first resource mapping for the particular resource from the first storage unit;
adding a second resource mapping for the particular resource to the second storage unit; and
releasing the latch on the first storage unit.

12. The computer-program product of claim 11, wherein the request for the particular resource is a first request for the particular resource, and wherein the set of actions further includes:
receiving a second request for the particular resource; and
based at least in part on the second request, accessing the second storage unit to add an entry based on the second request to a queue of one or more locks reserved for the particular resource.

13. The computer-program product of claim 11, wherein the determining that the particular resource maps to the second storage unit and previously mapped to the first storage unit comprises:
applying a hashing algorithm to a resource name of the particular resource, wherein the hashing algorithm determines an identifier used to navigate to the particular resource.

14. The computer-program product of claim 11, wherein the second storage unit is ordered between the first storage unit and a third storage unit,
wherein each of the first storage unit, the second storage unit, and the third storage units is associated with one or more numerical identifiers, and
wherein the one or more numerical identifier for each of the one or more data storage units is in ascending numerical order from the first storage unit to the third storage unit.

15. The computer-program product of claim 11, wherein the one or more conditions comprise a metric of access to the first storage unit being above a threshold value.

16. A system comprising:
one or more processors;
one or more non-transitory computer-readable media storing instructions, which, when executed by the system, cause the system to perform a set of actions including:
determining that one or more conditions have been satisfied for resizing at least a first storage unit of a hash table;
creating a second storage unit for the hash table;
referencing, using one or more references, the first storage unit from the second storage unit;
updating a hash table header to enable both the first storage unit and the second storage unit for routing new hash table requests;
receiving a request for a particular resource;
determining that the particular resource maps to the second storage unit and previously mapped to the first storage unit;
identifying the first storage unit based at least in part on at least one of the one or more references of the second storage unit;
acquiring a latch on the first storage unit;
using the acquired latch to remove a first resource mapping for the particular resource from the first storage unit;
adding a second resource mapping for the particular resource to the second storage unit; and
releasing the latch on the first storage unit.

17. The system of claim 16, wherein the request for the particular resource is a first request for the particular resource, and wherein the set of actions further includes:
receiving a second request for the particular resource; and
based at least in part on the second request, accessing the second storage unit to add an entry based on the second request to a queue of one or more locks reserved for the particular resource.

18. The system of claim 16, wherein the determining that the particular resource maps to the second storage unit and previously mapped to the first storage unit comprises:
applying a hashing algorithm to a resource name of the particular resource, wherein the hashing algorithm determines an identifier used to navigate to the particular resource.

19. The system of claim 16, wherein the second storage unit is ordered between the first storage unit and a third storage unit,
wherein each of the first storage unit, the second storage unit, and the third storage units is associated with one or more numerical identifiers, and
wherein the one or more numerical identifier for each of the one or more data storage units is in ascending numerical order from the first storage unit to the third storage unit.

20. The system of claim 16, wherein the one or more conditions comprise a metric of access to the first storage unit being above a threshold value.
